(19) United States
(12) Patent Application Publication
(10) Pub. No.: US 2005/0191066 A1
(43) Pub. Date: Sep. 1, 2005

(54) Image forming apparatus

(75) Inventor: Fumiya Yamazaki, Shizuoka-ken (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/063,644

(22) Filed: Feb. 24, 2005

(30) Foreign Application Priority Data
Mar. 1, 2004 (JP) 2004-055984

(51) Int. Cl. G03G 15/00; G03G 15/16

(52) U.S. Cl. 399/21; 399/101; 399/297

(57) ABSTRACT

There is disclosed an image forming apparatus comprising: an intermediate transferring member suitable for transferring an image formed by a recording material; a cleaner suitable for recovering the recording material on the intermediate transferring member; and a controller suitable for selectively executing a step of stopping the intermediate transferring member while the recording material remains on the intermediate transferring member and a step of stopping the intermediate transferring member after recovering the recording material on the intermediate transferring member by the cleaner based on conditions in a case where the conditions for stopping the intermediate transferring member during rotation of the intermediate transferring member are satisfied. Consequently, a serious situation such as failure caused when the intermediate transferring member continues to be rotated in order to be cleaned is prevented in advance.

### BACKGROUND OF THE INVENTION

1. Field of the Invention

The present invention relates to image forming apparatuses such as a printer and a copying machine, particularly to an image forming apparatus having an intermediate transferring member.

2. Related Background Art

An image forming apparatus has been known which forms an image by a recording material on a photosensitive member having charging, exposing, and developing means therearound and which transfers (primary transfer) the image by the recording material onto an intermediate transferring member and which thereafter transfers (secondary transfer) the image by the recording material to a transfer material such as a transfer sheet which is a recording medium from the intermediate transferring member. In this electrophotograph system image forming apparatus, when a printing process is interrupted during printing because of occurrence of jam, and the recording material attached onto the intermediate transferring member is left to stand, the recording material adheres to the intermediate transferring member, phenomenon such as cleaning defect occurs at the next printing time, and an image defect sometimes results. For example, in Japanese Patent Application Laid-Open No. 2002-116640, an image forming apparatus has been proposed in which the recording material attached to the intermediate transferring member is cleaned by a cleaner at a printing stop time, and thereafter the intermediate transferring member is stopped.

However, in the above-described conventional image forming apparatus, even when jam occurs, the intermediate transferring member is not stopped until the recording material on the intermediate transferring member is recovered by the cleaner, a transfer material is recovered by the cleaner, for example, in a case where the jam occurs in such a manner that the transfer material winds around the intermediate transferring member. A process by a user after the jam becomes-troublesome, and there has been a problem that usability excessively worsens, or a cleaner section is broken.

Moreover, in the conventional image forming apparatus, when the jam is detected, the recording material on the intermediate transferring member is recovered by the cleaner, and the intermediate transferring member is then stopped. However, for example, when the jam occurs or failure is detected in a sheet discharge device in which any jam cannot be detected by the image forming apparatus alone, there has been a problem that the recording material attached onto the intermediate transferring member is sometimes left to stand, and fixed.

### SUMMARY OF THE INVENTION

The present invention solves the above-described problem of an image forming apparatus.

Another object of the present invention is to provide an image forming apparatus capable of selecting a stop method for stopping the apparatus after cleaning an intermediate transferring member and a stop method for immediately stopping the apparatus to thereby stop the apparatus depending on a cause for interrupting a printing process, and capable of preventing a serious situation such as failure in advance while preventing a recording material from being fixed to the intermediate transferring member in a case where the printing process is interrupted during printing for a cause such as jam.

A further object of the present invention is to provide an image forming apparatus capable of instantly interrupting cleaning of an intermediate transferring member to thereby prevent a serious situation such as failure in a case where conditions for immediately interrupting a printing process during the cleaning of the intermediate transferring member are satisfied.

A further object of the present invention is to provide an image forming apparatus capable of selecting a stop method for stopping the apparatus after cleaning an intermediate transferring member or a stop method for immediately stopping the apparatus to thereby stop the apparatus depending on a cause for interrupting a printing process, and capable of preventing a serious situation such as failure in advance while preventing a recording material from being fixed to the intermediate transferring member even in a case where the printing process is interrupted on stop conditions except jam in the image forming apparatus.

A further object of the present invention is to provide an image forming apparatus comprising: an intermediate transferring member suitable for transferring an image formed by a recording material; a cleaner suitable for recovering the recording material on the intermediate transferring member; and a controller suitable for selectively executing a step of stopping the intermediate transferring member while the recording material remains on the intermediate transferring member and a step of stopping the intermediate transferring member after recovering the recording material on the intermediate transferring member by the cleaner based on conditions in a case where the conditions for stopping the intermediate transferring member during rotation of the intermediate transferring member are satisfied.

A further object of the present invention is to provide an image forming apparatus comprising: an intermediate transferring member suitable for transferring an image formed by a recording material; a cleaner suitable for recovering the recording material on the intermediate transferring member; and a controller suitable for stopping the intermediate transferring member during rotation of the intermediate transferring member based on predetermined conditions, wherein the controller judges whether or not it is possible to continue the rotation of the intermediate transferring member in order to recover the recording material on the intermediate transferring member by the cleaner, and stops the intermediate transferring member at a timing based on judgment result.

According to the present invention, in a case where the printing process is interrupted during the printing, for example, because of jam, with a winding jam on the intermediate transferring member, the apparatus is stopped by the stop method of instantly stopping the apparatus. With jam other than the winding jam on the intermediate transferring member, the apparatus is stopped by the stop method for stopping the apparatus after cleaning the intermediate transferring member. Therefore, even when the winding jam on the intermediate transferring member occurs, the serious situation including the failure of the cleaner can be prevented in advance. Moreover, with the jam other than the winding jam on the intermediate transferring member, toner can be prevented from being fixed to the intermediate transferring member.

Furthermore, in a case where another recording medium is conveyed at a time when the jam other than the winding jam on the intermediate transferring member occurs, the intermediate transferring member can be cleaned without causing multiple jam in the image forming apparatus which instantly stops the conveying to thereby clean the intermediate transferring member.

Moreover, in a case where another recording medium is conveyed at a time when the jam other than the winding jam on the intermediate transferring member occurs, with an image forming apparatus which stops the conveying of the recording medium after conveying the recording medium to a position where the recording medium is easily taken out by a user and which cleans the intermediate transferring member, there can be provided an image forming apparatus which facilitates a jam process and which has a satisfactory usability.

Furthermore, in a case where the conditions for immediately stopping the intermediate transferring member are satisfied during the process to convey the recording medium to a predetermined position or during the cleaning of the intermediate transferring member, the cleaning of the intermediate transferring member is instantly interrupted and stopped. Therefore, an image forming apparatus capable of preventing the serious situation including the failure can be provided.

Additionally, according to the present invention, there can be provided an image forming apparatus capable of selecting a stop method for stopping the apparatus after cleaning an intermediate transferring member and a stop method for immediately stopping the apparatus depending on a cause for the interrupting to thereby stop the apparatus, and capable of preventing a serious situation such as failure in advance while preventing a recording material from being fixed to the intermediate transferring member even in a case where a printing process is interrupted on stop conditions other than jam of the image forming apparatus.

Other objects, constitutions, and effects of the present invention will be apparent from the following detailed description and drawings.

### BRIEF DESCRIPTION OF THE DRAWINGS

FIG. 1A is a sectional view showing a constitution of an image forming apparatus according to an embodiment of the present invention;

FIG. 1B is a block diagram showing a constitution of a control system of the embodiment of the present invention;

FIG. 2 is a flowchart showing a control process of a first embodiment;

FIG. 3 is a flowchart showing a control process of a second embodiment;

FIG. 4 is a flowchart showing a control process of a third embodiment;

FIG. 5 is a flowchart showing a control process of a fourth embodiment;

FIG. 6 is comprised of FIGS. 6A and 6B showing flowcharts of a control process of a fifth embodiment;

FIG. 7 is comprised of FIGS. 7A and 7B showing flowcharts of a control process of a sixth embodiment;

FIG. 8 is comprised of FIGS. 8A and 8B showing flowcharts of a control process of a seventh embodiment; and

FIG. 9 is comprised of FIGS. 9A and 9B showing flowcharts of a control process of an eighth embodiment.

### DESCRIPTION OF THE PREFERRED EMBODIMENTS

Embodiments of the present invention will be described hereinafter with reference to the drawings.

### First Embodiment

A first embodiment of the present invention will be described.

In the description of the present embodiment, an image forming apparatus will be described. In a case where a printing process is interrupted during printing for a cause such as jam, the apparatus selects a stop method for stopping the apparatus after cleaning an intermediate transferring member, and a stop method for immediately stopping the apparatus without completing the cleaning of the intermediate transferring member while a recording material (toner) remains on the intermediate transferring member to thereby stop the apparatus depending on a cause for interrupting a printing process. Accordingly, the apparatus prevents a serious situation such as failure in advance while preventing the toner from being fixed to the intermediate transferring member.

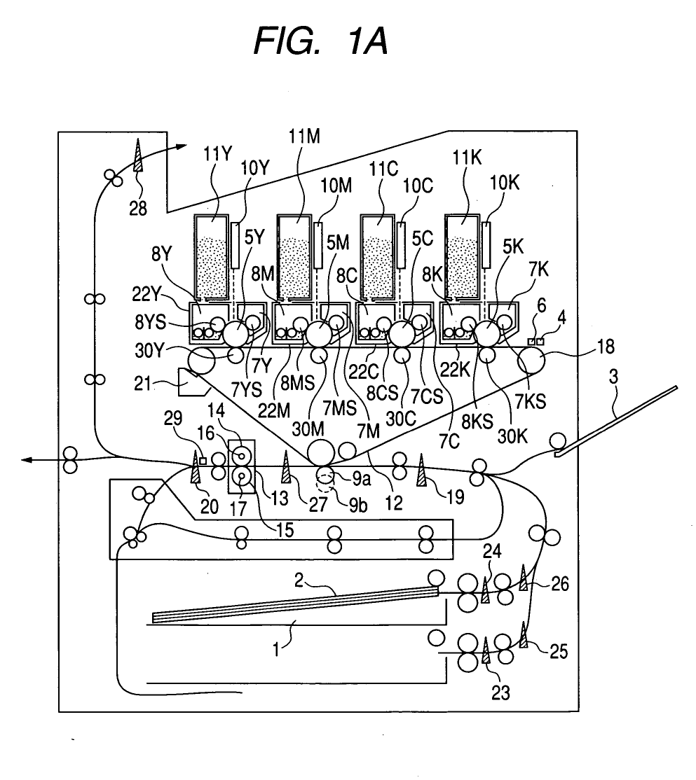

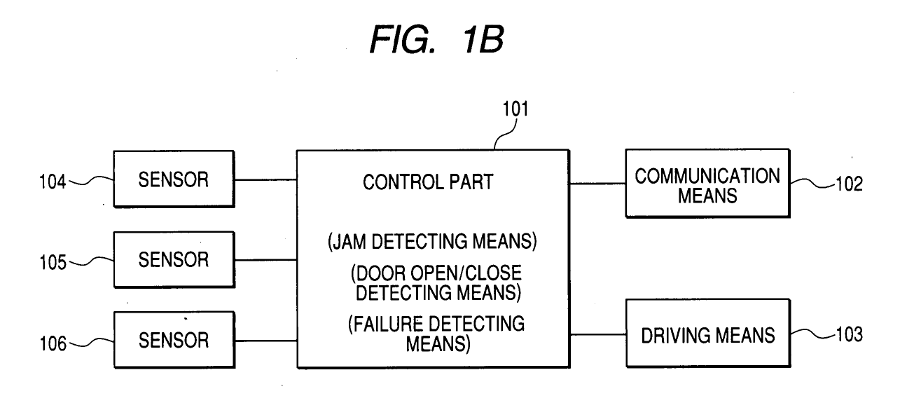

FIG. 1A is a sectional view showing a constitution of an image forming apparatus according to an embodiment of the present invention, and shows a schematic constitution of an electrophotograph system color image forming apparatus.

In FIG. 1A, reference numeral 1 denotes a sheet supply cassette; 2 denotes a transfer material (recording medium); 3 denotes an MP tray for manual insertion; 4 denotes a concentration detecting sensor; 5Y, 5M, 5C, 5K denote photosensitive drums; 6 denotes a register detecting sensor; 7Y, 7M, 7C, 7K denote charging units; 7YS, 7MS, 7CS, 7KS denote charging sleeves; 8Y, 8M, 8C, 8K denote developing units; 8YS, 8MS, 8CS, 8KS denote developing sleeves; 9a, 9b denote secondary transfer rollers; 10Y, 10M, 10C, 10K denote scanner parts; 11Y, 11M, 11C, 11K denote toner cartridges containing toner which is a recording material; 12 denotes an intermediate transferring member constituted as an intermediate transferring belt; 13 denotes a fixing part; 14 denotes a fixing roller; 15 denotes a pressurizing roller; 16, 17 denote heaters; 18 denotes an intermediate transferring member driving roller; 19 denotes a sensor before register; 20 denotes a fixing part sheet discharge sensor; 21 denotes a cleaner; 22Y, 22M, 22C, 22K denote developing cartridges; 23, 24, 25, 26 denote sheet supply sensors; 27 denotes a sensor before the fixing part; 28 denotes a sheet discharge sensor; 29 denotes a color sensor; and 30Y, 30M, 30C, 30K denote transfer rollers.

In the photosensitive drums 5Y, 5M, 5C, 5K, an outer periphery of an aluminum cylinder is coated with an organic light conducting layer, and a driving force of a driving motor (not shown) is transmitted to thereby rotate the drums. The driving motor rotates the photosensitive drums 5Y, 5M, 5C, 5K in a shown counterclockwise direction in accordance with an image forming operation. Exposure light to the photosensitive drums 5Y, 5M, 5C, 5K is sent from the scanner parts 10Y, 10M, 10C, 10K, the surfaces of the photosensitive drums 5Y, 5M, 5C, 5K are selectively exposed, and electrostatic latent images are formed.

Moreover, as primary charging means, four injection charging units 7Y, 7M, 7C, 7K for charging the respective photosensitive drums 5Y, 5M, 5C, 5K of yellow (Y), magenta (M), cyan (C), black (K) are disposed for each station, and the respective injection charging units 7Y, 7M, 7C, 7K are provided with the charging sleeves 7YS, 7MS, 7CS, 7KS.

Moreover, as developing means, four developing units 8Y, 8M, 8C, 8K for developing images of the yellow (Y), magenta (M), cyan (C), black (K) are disposed for each station in order to visualize the formed electrostatic latent images, and the respective developing units 8Y, 8M, BC, 8K are provided with the developing sleeves 8YS, 8MS, 8CS, 8KS. The respective developing units 8Y, 8M, 8C, 8K are detachably attached.

The intermediate transferring member 12 contacts the photosensitive drums 5Y, 5M, 5C, 5K, rotates in a clockwise direction at a color image forming time, rotates with the rotation of the photosensitive drums 5Y, 5M, 5C, 5K, and receives transfer of visible images. The intermediate transferring member 12 contacts the secondary transfer roller 9a described later at the image forming time, and holds/conveys the transfer material 2. Accordingly, color visible images on the intermediate transferring member 12 are simultaneously superimposed/transferred onto the transfer material 2.

The secondary transfer roller 9a abuts on the intermediate transferring member 12 while the color visible images are superimposed/transferred onto the intermediate transferring member 12, and is detached in a position of 9b at a printing process end time.

The fixing part 13 conveys the transfer material 2, while fixing the transferred color visible images. As shown in FIGS. 1A and 1B, the fixing part 13 comprises the fixing roller 14 for heating the transfer material 2, and the pressurizing roller 15 for pressing the transfer material 2 onto the fixing roller 14. The fixing roller 14 and the pressurizing roller 15 are formed in hollow shapes, and contain the heaters 16, 17 therein, respectively. That is, the transfer material 2 holding the color visible images is conveyed by the fixing roller 14 and pressurizing roller 15, and heat and pressure are applied to the transfer material to thereby fix the toner onto the surface of the material.

The transfer material 2 onto which the visible images have been fixed is thereafter discharged to a sheet discharging part by a discharging roller, and accordingly the image forming operation ends.

The cleaner 21 cleans (recovers) the toner remaining on the photosensitive drums 5Y, 5M, 5C, 5K and the intermediate transferring member 12. Waste toner after transferring the visible images formed on the photosensitive drums 5Y, 5M, 5C, 5K by the toner onto the intermediate transferring member 12, or waste toner after transferring four color visible images formed on the intermediate transferring member 12 to the transfer material 2 is stored in a cleaner container.

FIG. 1B is a block diagram showing a constitution of a control system of the image forming apparatus constituted as described above. In the drawing, reference numeral 101 denotes a control part (control means) which controls the whole image forming apparatus, and the part controls communication means 102 for performing communication with the outside, and driving means 103 including the intermediate transferring member driving roller 18 which drives the intermediate transferring member 12. This control part 101 inputs signals from sensors 104, 105, 106 which detect jam, door open/close, and failure, and constitutes jam detecting means, door open/close detecting means, and failure detecting means.

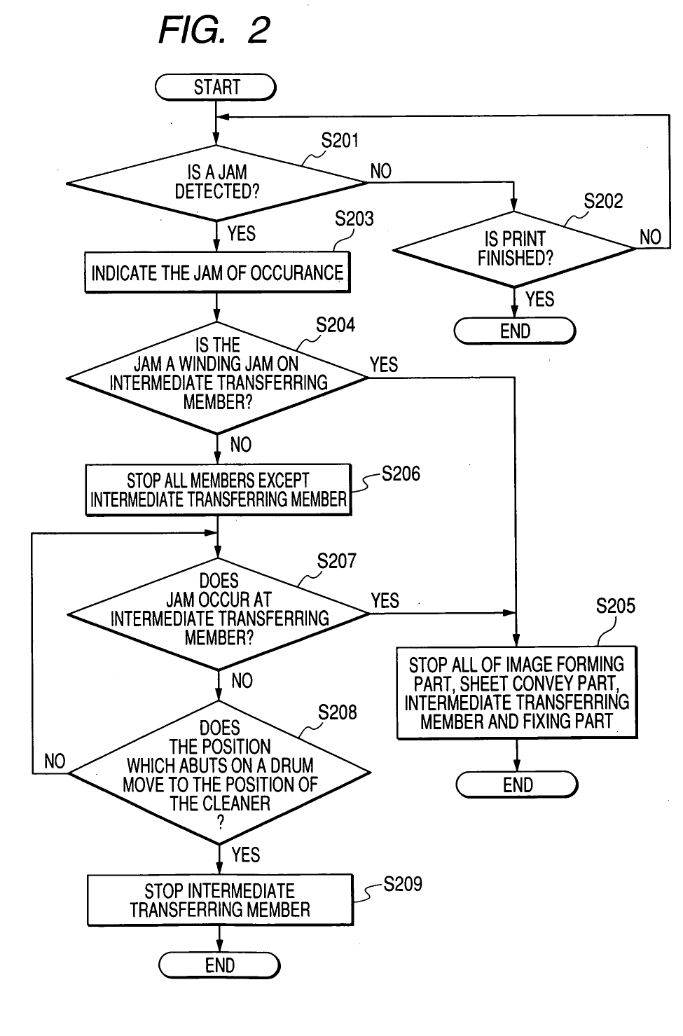

FIG. 2 is a flowchart showing a control process of the present embodiment, and shows jam detection during printing or calibrating including sheet conveyance, and a stop process operation at a jam detection time.

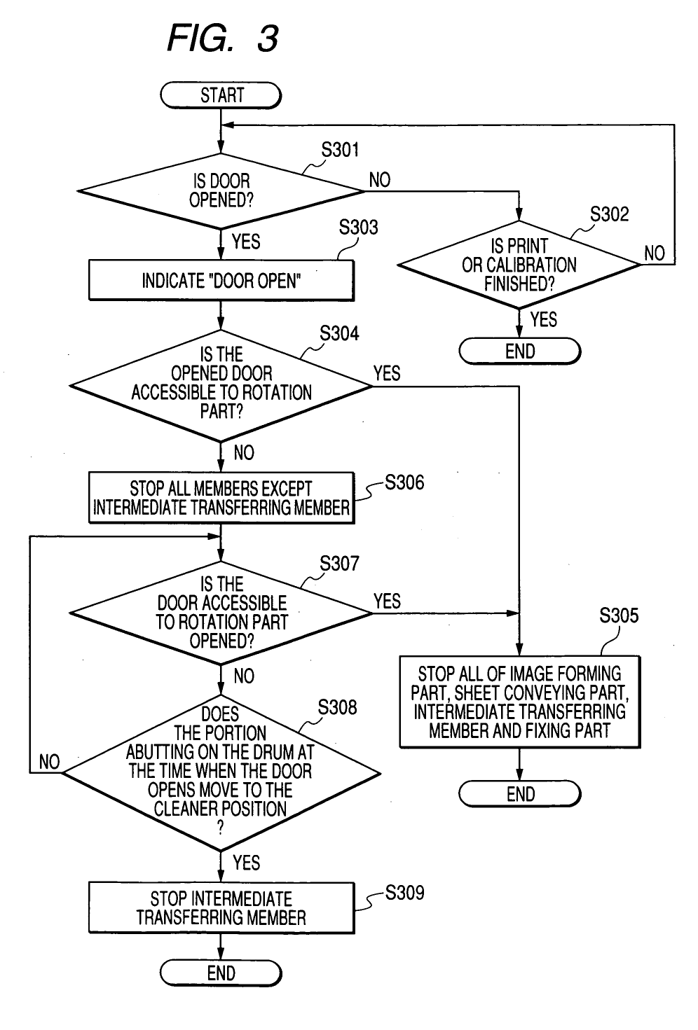

It is to be noted that the control processes of this flowchart and flowcharts of FIGS. 3 to 9 described later are executed in accordance with program stored beforehand by a CPU of the control part 101 of FIG. 1B.

First, it is judged in step S201 whether or not a jam occurs during printing or calibrating involving sheet conveyance. When the jam does not occur, it is judged in step S202 whether or not the printing (or the calibration) is finished. When the printing (or the calibration) is finished, a jam detecting process ends. When the printing (or the calibration) is not finished in the step S202, the process returns to the step S201.

When the jam is detected in the step S201, the occurrence of jam is reported (indicated) to a user in step S203. At this time, as the jam detected in the step S201, for example, there are a sheet supply delay jam in a case where a sheet tip is not detected in the sheet supply sensor 26 within a predetermined time after starting sheet supply from the sheet supply cassette 1, a winding jam on the intermediate transferring member in a case where the sheet tip is not detected in the sensor 27 before the fixing part within a predetermined time after starting the sheet supply and the like.

Thereafter, it is judged in step S204 whether or not the generated jam is the intermediate transferring member winding jam indicating that the recording medium winds around the intermediate transferring member. Accordingly, it is judged whether or not it is possible to continue rotation of the intermediate transferring member 12. As a result, with the intermediate transferring member winding jam, in step S205, a high-pressure circuit for forming the image is cut, and the image forming apparatus including a sheet conveying part, the intermediate transferring member 12, the fixing part 13 and the like is instantly stopped to thereby finish a process at a jam occurrence time. That is, in this case, since the cleaning of the intermediate transferring member 12 is not performed, the recording material remains on the intermediate transferring member. When the type of the jam is other than the intermediate transferring member winding jam in the step S204, in step S206, the sheet conveying part relating to the sheet conveyance except the intermediate transferring member, and the fixing part 13 are instantly stopped. While the rotating intermediate transferring member 12 is held, the intermediate transferring member starts to be cleaned, and the process shifts to step S207.

In the step S207, it is judged whether or not the intermediate transferring member winding jam occurs as a condition on which the apparatus has to be soon stopped during the cleaning of the intermediate transferring member. When it is judged in the step S207 that the intermediate transferring member winding jam occurs, the image forming apparatus is instantly stopped in the step S205, and the process at the jam occurrence time is finished without completing the cleaning of the intermediate transferring member 12. When it is judged in the step S207 that the winding jam on the intermediate transferring member does not occur, the process shifts to step S208.

It is judged in the step S208 whether or not a portion of the intermediate transferring member 12 abutting on the photosensitive drum 5Y at the occurrence time of the jam detected in the step S201 has moved to a position of the cleaner 21, that is, whether or not the cleaning of the intermediate transferring member 12 is completed. When the part of the intermediate transferring member 12 that has contacted the photosensitive drum 5Y at the jam occurrence time does not move to the position of the cleaner 21 in the step S208, the process shifts to the step S207. When the part of the intermediate transferring member 12 that has contacted the photosensitive drum 5Y at the jam occurrence time is judged to have moved to the position of the cleaner 21 in the step S208, the cleaning of the intermediate transferring member 12 is completed, and therefore the process shifts to step S209. Moreover, the intermediate transferring member 12 is stopped in the step S209, and the process at the jam occurrence time ends. Thus, when a stop timing of the intermediate transferring member is delayed, all the recording material on the intermediate transferring member is recovered.

As described above, in the image forming apparatus of the present embodiment, in the case where the printing process is interrupted during the printing because of the jam, with the winding jam on the intermediate transferring member, the apparatus is stopped in the stop method for instantly stopping the apparatus without completing the cleaning while the recording material remains. With the jam other than the winding jam on the intermediate transferring member, the apparatus is stopped by the stop method for stopping the apparatus after cleaning the intermediate transferring member. Therefore, even in a case where the intermediate transferring member winding jam occurs, a serious situation such as failure of the cleaner can be prevented in advance. Moreover, with the jam other than the intermediate transferring member winding jam, the toner can be prevented from being fixed to the intermediate transferring member. It is detected even during the cleaning of the intermediate transferring member whether or not the winding of the recording medium around the intermediate transferring member occurs. When it is judged that the winding occurs, the cleaning of the intermediate transferring member is instantly interrupted to thereby stop the apparatus, and therefore the serious situation including the failure of the cleaner can be prevented in advance.

### Second Embodiment

A second embodiment of the present invention will be described. In the first embodiment, it has been described that in the case where the printing process is interrupted during the printing because of the jam, with the winding jam on the intermediate transferring member, the apparatus is stopped in the stop method for instantly stopping the apparatus without completing the cleaning of the intermediate transferring member while the recording material (toner) remains on the intermediate transferring member. With the jam other than the winding jam on the intermediate transferring member, the apparatus is stopped by the stop method for stopping the apparatus after cleaning the intermediate transferring member. Therefore, even in the case where the intermediate transferring member winding jam occurs, a serious situation such as failure of the cleaner can be prevented in advance. Moreover, with the jam other than the intermediate transferring member winding jam, the toner can be prevented from being fixed to the intermediate transferring member. This image forming apparatus has been described.

In the description of the present embodiment, an image forming apparatus will be described. In the apparatus, in a case where a door is opened during printing or calibrating, when the door is opened, and it is accordingly possible for a user to touch a rotation part such as an intermediate transferring member, the apparatus is stopped by a stop method for instantly stopping the apparatus. Even when the door is opened, it is impossible for the user to touch the rotation part, for example, the intermediate transferring member, then the apparatus is stopped by a stop method for stopping the apparatus after cleaning the intermediate transferring member, and a serious situation in which the user is injured at a jam process time is prevented in advance. Moreover, toner is prevented from being fixed to the intermediate transferring member.

In the description of the present embodiment, description of contents similar to those of the first embodiment will be omitted.

FIG. 3 is a flowchart showing a control process of the present embodiment, and shows door open detection during the printing or the calibrating for determining image forming conditions of the image forming apparatus, and an operation of a stop process at a door open detection time.

First, it is judged in step S301 whether or not the door is opened during the printing or the calibrating for determining the image forming conditions. When the door is not opened, it is judged in step S302 whether or not the printing (or the calibration) is finished. When the printing (or the calibration) is finished, a door open detection process ends. When the printing (or the calibration) is not finished in the step S302, the process returns to the step S301.

When it is detected in the step S301 that the door has been opened, in step S303 it is reported (indicated) to the user that the door has been opened. Thereafter, it is judged in step S304 whether or not the door for the user to be accessible to the rotation part, for example, the intermediate transferring member 12 has been opened, when the door is opened. Accordingly, it is judged whether or not it is possible to continue the rotation of the intermediate transferring member 12. As a result, in a case where the door for the user to be accessible to the rotation part is opened, in step S305, a high-pressure circuit for forming the image is cut, and the image forming apparatus including a sheet conveying part, intermediate transferring member 12, fixing part 13 and the like is instantly stopped to thereby end a process at the door open detection time. That is, in this case, since the intermediate transferring member 12 is not cleaned, the recording material remains on the intermediate transferring member. When the door for the user to be inaccessible to the rotation part is opened in the step S304, in step S306, the sheet conveying part relating to sheet conveyance except the intermediate transferring member 12, and the fixing part 13 are instantly stopped. The rotating intermediate transferring member 12 is held, the intermediate transferring member starts to be cleaned, and the process shifts to step S307.

It is judged in the step S307 whether or not the door for the user to be accessible to the rotation part is opened as a condition for instantly stopping the apparatus during the cleaning of the intermediate transferring member. When it is judged in the step S307 that the door accessible to the rotation part has been opened, in the step S305, the image forming apparatus is instantly stopped, and the process at the door open detection time is finished without completing the cleaning of the intermediate transferring member 12. When it is judged in the step S307 that the door accessible to the rotation part is not opened, the process shifts to step S308.

It is judged in the step S308 whether or not a portion of the intermediate transferring member 12 that has abutted on a photosensitive drum 5Y at the time when it is detected in the step S301 that the door opens has moved to a position of a cleaner 21. That is, it is judged whether or not the cleaning of the intermediate transferring member 12 has been completed. When the portion of the intermediate transferring member 12 abutting on the photosensitive drum 5Y at the door open detection time does not move to the position of the cleaner 21 in the step S308, the process shifts to the step S307. When it is judged that the portion of the intermediate transferring member 12 abutting on the photosensitive drum 5Y at the door open detection time has moved to the position of the cleaner 21 in the step S308, the process shifts to the step S309. Moreover, in the step S309, the intermediate transferring member 12 is stopped, and the process at the door open detection time is finished. Thus, when a stop timing of the intermediate transferring member is delayed, all the recording material on the intermediate transferring member is recovered.

In the description of the present embodiment, an example has been described in which it is judged whether or not the door for the user to be accessible to the rotation part has been opened as the conditions for stopping the intermediate transferring member during the cleaning of the intermediate transferring member. The conditions for stopping the intermediate transferring member during the cleaning of the intermediate transferring member include occurrence of a winding jam of a recording medium onto the intermediate transferring member as described in the first embodiment, in addition to the door open.

Moreover, in the present embodiment, a case where the door is opened has been described as conditions for starting the cleaning of the intermediate transferring member. The conditions include not only the case where the door has been opened but also a case where a jam other than the winding jam of the recording medium onto the intermediate transferring member occurs as in the first embodiment to thereby start the cleaning of the intermediate transferring member.

As described above, in the image forming apparatus of the present embodiment, in a case where the door is opened during the printing or the calibrating, when the door is opened, and it is accordingly possible for the user to touch the rotation part, for example, the intermediate transferring member, the apparatus is stopped by the stop method for instantly stopping the apparatus. Even when the door is opened, it is impossible for the user to touch the rotation part, for example, the intermediate transferring member, then the apparatus is stopped by the stop method for stopping the apparatus after cleaning the intermediate transferring member, and the serious situation in which the user is injured at the jam process time is prevented in advance. Moreover, the toner can be prevented from being fixed to the intermediate transferring member.

### Third Embodiment

A third embodiment of the present invention will be described.

In the description of the present embodiment, an image forming apparatus will be described. In the apparatus, in a case where failure is detected during printing or calibrating, when an intermediate transferring member is rotated as such, and accordingly there is a possibility that another failure is caused, the apparatus is stopped by a stop method for instantly stopping the apparatus without completing the cleaning of the intermediate transferring member while a recording material (toner) remains on the intermediate transferring member. Even when the intermediate transferring member continues to be rotated as such, a multiple failure is not caused. In this case, the apparatus is stopped by a stop method for stopping the apparatus after cleaning the intermediate transferring member. Consequently, a serious situation including multiple failure is prevented in advance, and the toner is prevented from being fixed to the intermediate transferring member.

In the description of the present embodiment, description of contents similar to those of the first embodiment will be omitted.

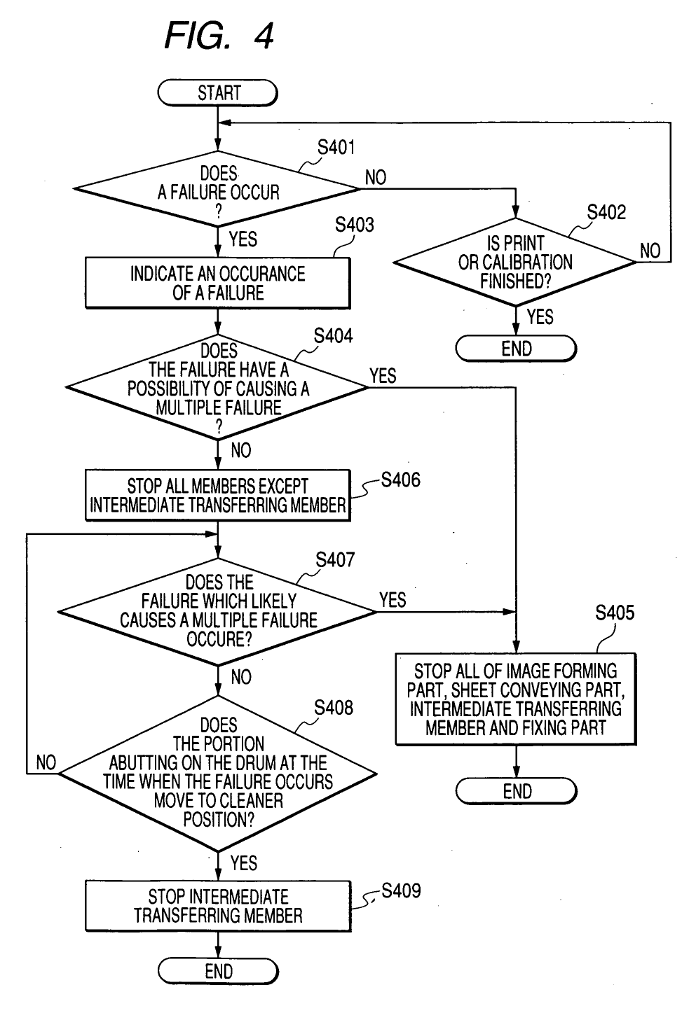

FIG. 4 is a flowchart showing a control process of the present embodiment, and shows failure detection during the printing or the calibrating for determining image forming conditions of the image forming apparatus, and an operation of a stop process at a failure detection time.

First, it is judged in step S401 whether or not the failure occurs during the printing or the calibrating for determining the image forming conditions. When the failure does not occur opened, it is judged in step S402 whether or not the printing (or the calibration) is finished. When the printing (or the calibration) is finished, a failure detection process ends. When the printing (or the calibration) is not finished in the step S402, the process returns to the step S401.

When it is detected in the step S401 that the failure has occurred, in step S403 it is reported (indicated) to the user that the failure has occurred. Thereafter, it is judged in step S404 whether or not the failure possible to raise a multiple failure has occurred, when the intermediate transferring member 12 continues to be rotated, for example, because of a failure of a driving part for rotating the intermediate transferring member 12. Accordingly, it is judged whether or not it is possible to continue the rotation of the intermediate transferring member 12. As a result, in a case where the failure possible to raise the multiple failure occurs, in step S405, a high-pressure circuit for forming an image is cut, and the image forming apparatus including a sheet conveying part, intermediate transferring member 12, fixing part 13 and the like is instantly stopped to thereby end a process at the failure detection time. That is, in this case, since the intermediate transferring member 12 is not cleaned, the recording material remains on the intermediate transferring member. In a case where a failure impossible to raise a multiple failure occurs, even when the intermediate transferring member 12 continues to be rotated in step S404, the sheet conveying part relating to sheet conveyance except the intermediate transferring member 12, and the fixing part 13 are instantly stopped in step S406. The rotating intermediate transferring member 12 is held, the intermediate transferring member starts to be cleaned, and the process shifts to step S407.

It is judged in the step S407 whether or not the failure possible to raise the multiple failure occurs, when the intermediate transferring member 12 continues to be rotated as a condition for instantly stopping the apparatus during the cleaning of the intermediate transferring member. When it is judged in the step S407 that the failure possible to raise the multiple failure occurs, in the step S405, the image forming apparatus is instantly stopped, and the process at the failure detection time is finished without completing the cleaning of the intermediate transferring member 12. When it is judged in the step S407 that the failure possible to raise the multiple failure does not occur, the process shifts to step S408.

It is judged in the step S408 whether or not a portion of the intermediate transferring member 12 that has abutted on a photosensitive drum 5Y at the failure detection time in the step S401 has moved to a position of a cleaner 21. That is, it is judged whether or not the cleaning of the intermediate transferring member 12 has been completed. When the portion of the intermediate transferring member 12 abutting on the photosensitive drum 5Y at the failure detection time does not move to the position of the cleaner 21 in the step S408, the process shifts to the step S407. When it is judged in the step S408 that the portion of the intermediate transferring member 12 abutting on the photosensitive drum 5Y at the failure detection time has moved to the position of the cleaner 21, the process shifts to the step S409. Moreover, in the step S409, the intermediate transferring member 12 is stopped, and the process at the failure detection time is finished. Thus, when a stop timing of the intermediate transferring member is delayed, all the recording material on the intermediate transferring member is recovered.

In the description of the present embodiment, it is judged whether or not the failure possible to raise the multiple failure has occurred as the conditions for stopping the intermediate transferring member during the cleaning of the intermediate transferring member. The conditions for stopping the intermediate transferring member during the cleaning of the intermediate transferring member include opening of a door accessible to a rotation part as described in the second embodiment, and occurrence of a winding jam of a recording medium onto the intermediate transferring member as described in the first embodiment, in addition to the failure.

Moreover, in the present embodiment, a case where the failure impossible to raise the multiple failure has been described as conditions for starting the cleaning of the intermediate transferring member. The conditions include not only the occurrence of the failure but also a case where a door for the user to be inaccessible to the rotation part has been opened as in the second embodiment, and a case where a jam other than the winding jam of the recording medium onto the intermediate transferring member occurs as in the first embodiment to thereby start the cleaning of the intermediate transferring member.

As described above, in the image forming apparatus of the present embodiment, in the case where the failure is detected during the printing or the calibrating, when the intermediate transferring member is rotated as such, and accordingly there is a possibility that another failure is caused, the apparatus is stopped by the stop method for instantly stopping the apparatus. Even when the intermediate transferring member continues to be rotated as such, the multiple failure is not caused. In this case, the apparatus is stopped by the stop method for stopping the apparatus after cleaning the intermediate transferring member. Consequently, the serious situation including the multiple failure is prevented in advance, and the toner can be prevented from being fixed to the intermediate transferring member.

### Fourth Embodiment

A fourth embodiment of the present invention will be described.

In description of the present embodiment, in an image forming apparatus constituted in such a manner as to receive a signal for emergently stopping the apparatus from the outside, and stop, in a case where an emergency stop designation signal is detected during printing or calibrating, when a signal for instantly stopping the apparatus is received, the apparatus is stopped by a stop method for instantly stopping the apparatus without completing cleaning of an intermediate transferring member while a recording material (toner) remains on the intermediate transferring member. When the emergency stop designation signal is received in such a manner as to continue rotating the intermediate transferring member as such, the apparatus is stopped by a stop method for stopping the apparatus after cleaning the intermediate transferring member. Consequently, the apparatus is stopped by an optimum method in accordance with a purpose for stopping the apparatus. This image forming apparatus will be described.

In the description of the present embodiment, description of contents similar to those of the first embodiment will be omitted.

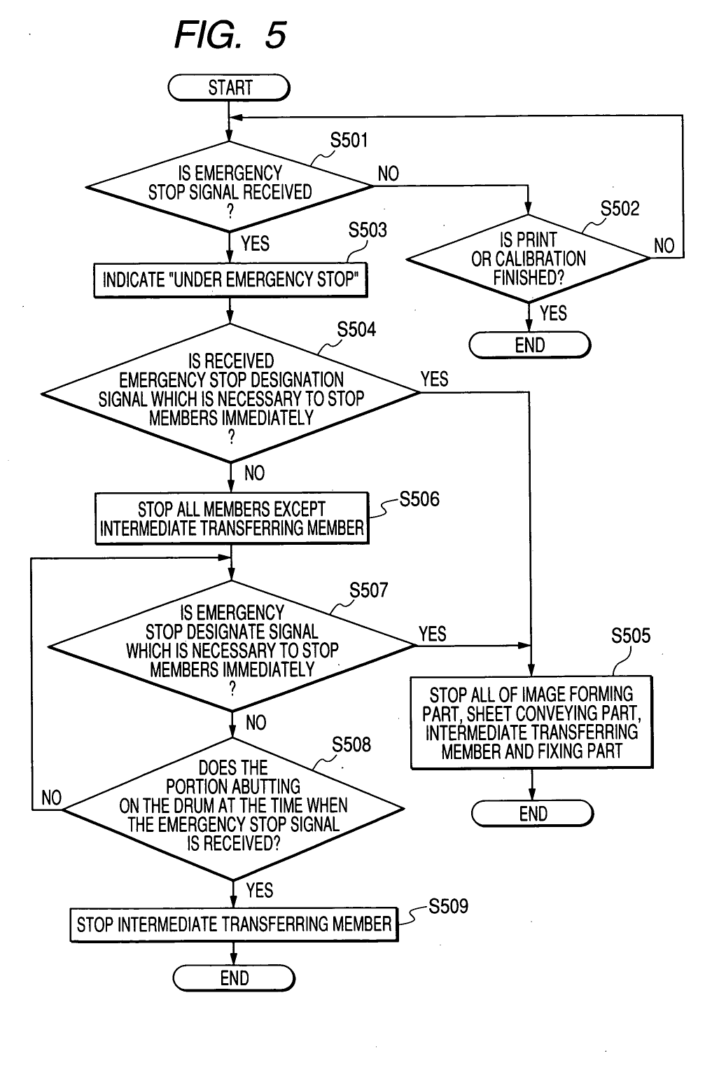

FIG. 5 is a flowchart showing a control process of the present embodiment, and shows emergency stop designation signal detection during the printing or the calibrating for determining image forming conditions of the image forming apparatus in the image forming apparatus constituted in such a manner as to receive the signal for emergently stopping the apparatus from the outside and stop, and an operation of a stop process at an emergency stop designation signal detection time.

First, it is judged in step S501 whether or not the emergency stop designation signal is received from the outside (a controller not shown, etc.) during the printing or the calibrating for determining the image forming conditions. When the emergency stop designation signal is not received, it is judged in step S502 whether or not the printing (or the calibration) is finished. When the printing (or the calibration) is finished, an emergency stop designation signal detection process ends. When the printing (or the calibration) is not finished in the step S502, the process returns to the step S501.

When it is detected in the step S501 that the emergency stop designation signal has been received, in step S503, “under emergency stop” is reported (indicated) to the user. Thereafter, it is judged in step S504 whether or not the emergency stop designation signal to stop the apparatus immediately has been received. The signal is issued in order to immediately stop the image forming apparatus and inspect a stop state of the apparatus. For example, a serviceman measures a slip amount of the sheet supply roller of the image forming apparatus in a test mode. Accordingly, it is judged whether or not it is possible to continue the rotation of the intermediate transferring member 12. As a result, in a case where the emergency stop designation signal to stop members immediately is received, in step S505, a high-pressure circuit for forming an image is cut, and the image forming apparatus including a sheet conveying part, intermediate transferring member 12, fixing part 13 and the like is instantly stopped to thereby end a process of emergency stop designation signal detection. That is, in this case, since the intermediate transferring member 12 is not cleaned, the recording material remains on the intermediate transferring member. In a case where a usual emergency stop designation signal is received in the step S504, the sheet conveying part relating to sheet conveyance except the intermediate transferring member 12, and the fixing part 13 are instantly stopped in step S506. The rotating intermediate transferring member 12 is held, the intermediate transferring member starts to be cleaned, and the process shifts to step S507.

It is judged in the step S507 whether or not the emergency stop designation signal to stop the members immediately has been received as a condition for instantly stopping the apparatus during the cleaning of the intermediate transferring member. When it is judged in the step S507 that the emergency stop designation signal to stop the members immediately has been received, in the step S505, the image forming apparatus is instantly stopped, and the process of the emergency stop designation signal detection is finished without completing the cleaning of the intermediate transferring member 12. When it is judged in the step S507 that the emergency stop designation signal to stop the members immediately is not received, the process shifts to step S508.

It is judged in the step S508 whether or not a portion of the intermediate transferring member 12 that has abutted on a photosensitive drum 5Y at the time when the emergency stop designation signal detected in the step S501 has been received has moved to a position of a cleaner 21. That is, it is judged whether or not the cleaning of the intermediate transferring member 12 has been completed. When the portion of the intermediate transferring member 12 abutting on the photosensitive drum 5Y does not move to the position of the cleaner 21 at the time when the emergency stop designation signal is received in the step S508, the process shifts to the step S507. When it is judged in the step S508 that the portion of the intermediate transferring member 12 abutting on the photosensitive drum 5Y has moved to the position of the cleaner 21 at the time when the emergency stop designation signal is received, the process shifts to the step S509. Moreover, in the step S509, the intermediate transferring member 12 is stopped, and the process of the emergency stop designation signal detection is finished. Thus, when a stop timing of the intermediate transferring member is delayed, all the recording material on the intermediate transferring member is recovered.

In the description of the present embodiment, it is judged whether or not the emergency stop designation signal to stop the members immediately has been received as the conditions for stopping the intermediate transferring member during the cleaning of the intermediate transferring member. The conditions for stopping the intermediate transferring member during the cleaning of the intermediate transferring member also include occurrence of a failure possible to raise a multiple failure as described in the third embodiment, opening of a door accessible to a rotation part as described in the second embodiment, and occurrence of a winding jam of a recording medium onto the intermediate transferring member as described in the first embodiment.

Moreover, in the present embodiment, a case where a usual emergency stop designation signal unnecessary to stop the intermediate transferring member immediately is received has been described as conditions for starting the cleaning of the intermediate transferring member. The conditions include not only the case where the emergency stop designation signal has been received but also occurrence of a failure impossible to raise the multiple failure as in the third embodiment, a case where a door for the user to be inaccessible to the rotation part has been opened as in the second embodiment, and a case where a jam other than the winding jam of the recording medium onto the intermediate transferring member occurs as in the first embodiment to thereby start the cleaning of the intermediate transferring member.

As described above, according to the image forming apparatus of the present embodiment, in the image forming apparatus constituted in such a manner as to receive the signal for emergently stopping the apparatus from the outside and stop, in the case where the emergency stop designation signal is detected during the printing or calibrating, when the signal for instantly stopping the apparatus is received, the apparatus is stopped by the stop method for instantly stopping the apparatus. When the emergency stop designation signal is received in such a manner as to continue rotating the intermediate transferring member as such, the apparatus is stopped by the stop method for stopping the apparatus after cleaning the intermediate transferring member. Consequently, the apparatus can be stopped by the optimum method in accordance with the purpose for stopping the apparatus.

### Fifth Embodiment

A fifth embodiment of the present invention will be described.

In the first embodiment, it has been described that in the case where the printing process is interrupted during the printing because of the jam, with the winding jam on the intermediate transferring member, the apparatus is stopped in the stop method for instantly stopping the apparatus without completing the cleaning of the intermediate transferring member while the recording material (toner) remains on the intermediate transferring member. With the jam other than the winding jam on the intermediate transferring member, while the sheet is being conveyed, the sheet conveyance is instantly stored, the rotating intermediate transferring member is held as such, and the apparatus is stopped by the stop method for stopping the intermediate transferring member after cleaning the intermediate transferring member. Therefore, a multiple jam is not caused. Even in the case where the intermediate transferring member winding jam occurs, a serious situation such as failure of the cleaner can be prevented in advance. Moreover, with the jam other than the intermediate transferring member winding jam, the toner can be prevented from being fixed to the intermediate transferring member. This image forming apparatus has been described.

In the description of the present embodiment, an image forming apparatus will be described. In a case where a printing process is interrupted during printing for a cause such as jam, with a winding jam on an intermediate transferring member, the whole apparatus is stopped by a stop method for immediately stopping the apparatus without completing the cleaning of the intermediate transferring member while a recording material (toner) remains on the intermediate transferring member. With a jam other than the intermediate transferring member winding jam, when a sheet is being conveyed, the sheet is conveyed to a position where a user easily removes the sheet, and thereafter the apparatus is stopped. The rotating intermediate transferring member is held as such, and the apparatus is stopped in a stop method for stopping the intermediate transferring member after cleaning the intermediate transferring member. Furthermore, in a case where the intermediate transferring member winding jam is detected, when the sheet is being conveyed after the jam occurrence or when the intermediate transferring member is cleaned, the whole apparatus is stopped. This apparatus will be described.

Description similar to that of the first embodiment will be omitted.

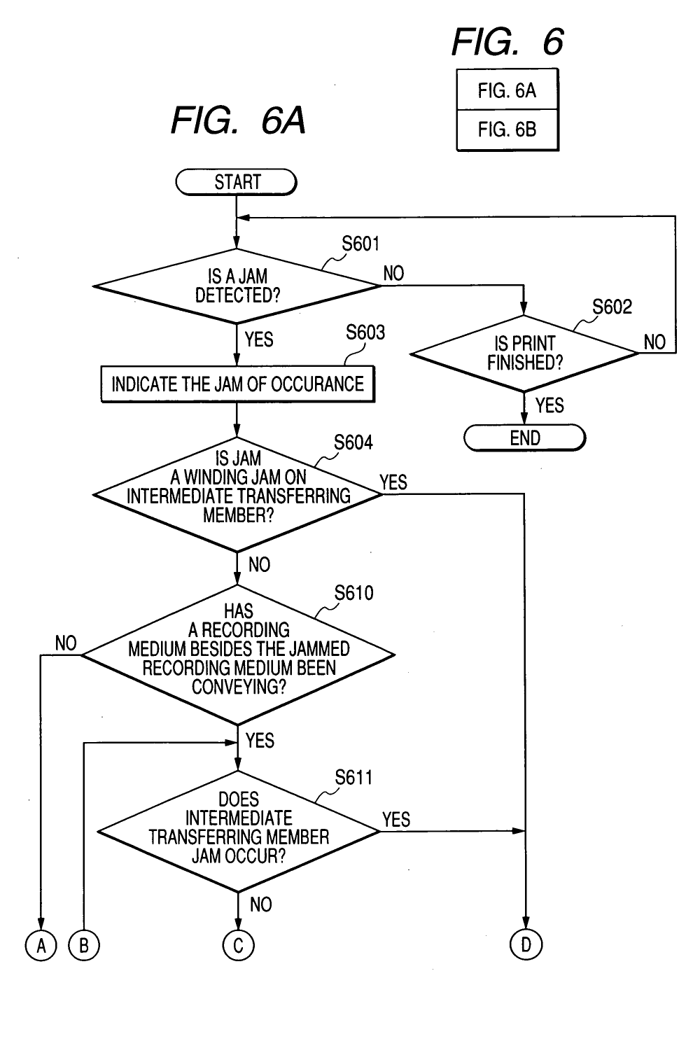

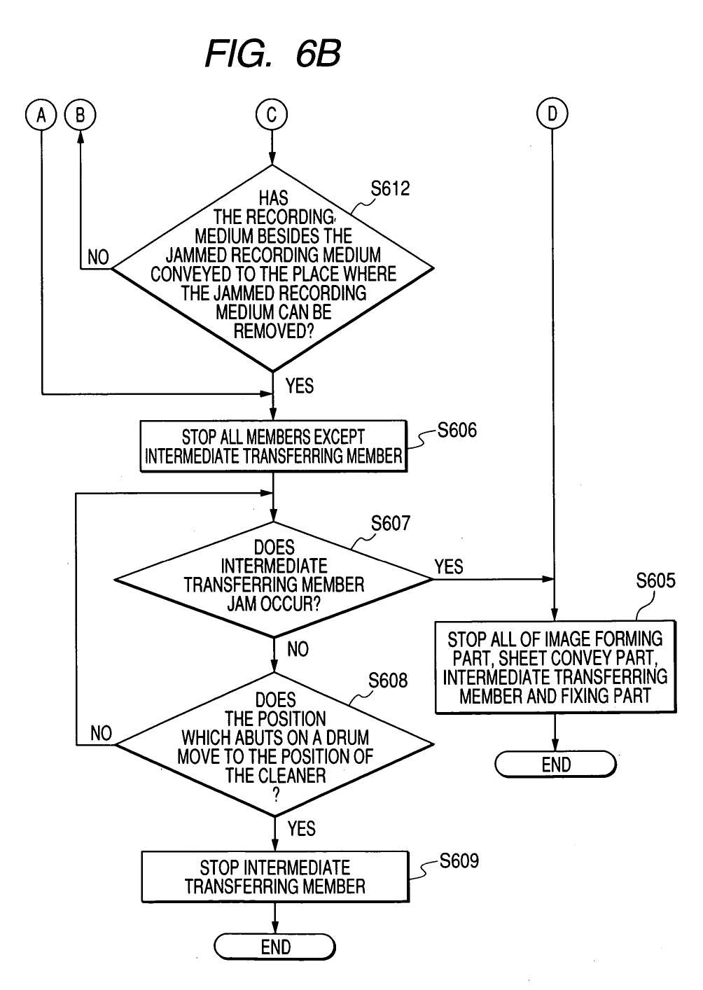

FIGS. 6A and 6B are flowcharts showing a control process of the present embodiment, and shows jam detection during printing or calibrating including sheet conveyance, and a stop process operation at a jam detection time.

A process of steps S601 to S603 to perform detection-display of the jam is similar to that of the steps S201 to S203 of FIG. 2 of the first embodiment.

It is judged in step S604 whether or not the generated jam is the intermediate transferring member winding jam indicating that the recording medium winds around the intermediate transferring member. Accordingly, it is judged whether or not it is possible to continue rotation of the intermediate transferring member 12. As a result, with the intermediate transferring member winding jam, in step S605, a high-pressure circuit for forming an image is cut, and the image forming apparatus including a sheet conveying part, intermediate transferring member 12, fixing part 13 and the like is instantly stopped to thereby finish a process at a jam occurrence time. That is, in this case, since the cleaning of the intermediate transferring member 12 is not performed, the recording material remains on the intermediate transferring member. When the type of the jam is other than the intermediate transferring member winding jam in the step S604, the process shifts to step S610.

It is judged in the step S610 whether or not a recording medium besides a jammed recording medium has been conveyed in the image forming apparatus. When it is judged in the step S610 that the recording medium besides the jammed recording medium is not conveyed, the process shifts to step S606. When it is judged in the step S610 that the recording medium besides the jammed recording medium is conveyed, the conveyance of the recording medium is continued, and the process shifts to step S611.

In the step S611, it is judged whether or not the intermediate transferring member winding jam occurs as a condition on which the apparatus has to be soon stopped during the conveying of the recording medium. When it is judged in the step S611 that the intermediate transferring member winding jam occurs, the image forming apparatus is instantly stopped in the step S605, and the process at the jam occurrence time is finished without completing the cleaning of the intermediate transferring member 12. When it is judged in the step S611 that the winding jam on the intermediate transferring member does not occur, the process shifts to step S612. It is judged in step S612 whether or not the recording medium has been conveyed to a place where the medium is easily removed by the user. Here, the place where the recording medium is easily removed may be a position where a tip of the recording medium is conveyed beyond the fixing part sheet discharge sensor 20, or a position where a rear end of the recording medium is conveyed beyond the sheet discharge sensor 28 and discharged to the outside.

It is judged in the step S612 that the recording medium has been conveyed to the place where the medium is easily removed by the user, the process shifts to the step S606, and the sheet conveying part relating to the sheet conveyance except the intermediate transferring member, and the fixing part 13 are instantly stopped. While the rotating intermediate transferring member 12 is held as such, the intermediate transferring member starts to be cleaned, and the process shifts to step S607. When it is judged in the step S612 that the recording medium is not conveyed to the place where the recording medium is easily removed by the user, the process shifts to step S611.

A process after the cleaning of the intermediate transferring member is started in the step S606 is similar to that of the steps S208, S209 of FIG. 2 of the first embodiment.

As described above, in the image forming apparatus of the present embodiment, in the case where the printing process is interrupted during the printing because of the jam, with the winding jam on the intermediate transferring member, the whole apparatus is stopped by the stop method for immediately stopping the apparatus. With the jam other than the intermediate transferring member winding jam, when the sheet is being conveyed, the sheet is conveyed to the position where the user easily removes the sheet, and thereafter the apparatus is stopped. The rotating intermediate transferring member is held as such, and the apparatus is stopped in the stop method for stopping the intermediate transferring member after cleaning the intermediate transferring member. Furthermore, in the case where the intermediate transferring member winding jam is detected, when the sheet is being conveyed after the jam occurrence or when the intermediate transferring member is cleaned, the whole apparatus is instantly stopped. Therefore, even in a case where the intermediate transferring member winding jam occurs, a serious situation such as failure of the cleaner can be prevented in advance. Moreover, with the jam other than the winding on the intermediate transferring member, the toner can be prevented from being fixed to the intermediate transferring member.

Moreover, when the jam other than the winding jam on the intermediate transferring member occurs, the sheet is conveyed to the place where the recording medium is easily removed by the user, and the sheet conveyance is stopped. Therefore, usability can be enhanced.

Furthermore, it is detected whether or not the winding of the recording medium around the intermediate transferring member even during the sheet conveyance after the jam occurrence or during the cleaning of the intermediate transferring member. On judging that the winding has occurred, the cleaning of the intermediate transferring member is instantly interrupted, and the apparatus is stopped. Therefore, the serious situation including the failure of the cleaner can be prevented in advance.

### Sixth Embodiment

A sixth embodiment of the present invention will be described.

In the second embodiment, an image forming apparatus has been described. In the apparatus, in a case where a door is opened during printing or calibrating, when the door is opened, and it is accordingly possible for a user to touch a rotation part such as an intermediate transferring member, the apparatus is stopped by a stop method for instantly stopping the apparatus without completing the cleaning of the intermediate transferring member while a recording material (toner) remains on the intermediate transferring member. Even when the door is opened, it is impossible for the user to touch the rotation part, for example, the intermediate transferring member, the sheet conveyance is instantly stopped, and the rotating intermediate transferring member is held as such. The apparatus is stopped by a stop method for stopping the intermediate transferring member after cleaning the intermediate transferring member, and a serious situation in which the user is injured at a jam process time is prevented in advance. Moreover, the toner is prevented from being fixed to the intermediate transferring member.

In the present embodiment, an image forming apparatus will be described. In the apparatus, in the case where the door is opened during the printing or calibrating, when the door is opened, and it is accordingly possible for the user to touch the rotation part including the intermediate transferring member, the apparatus is stopped by the stop method for instantly stopping the apparatus without completing the cleaning of the intermediate transferring member while the recording material (toner) remains on the intermediate transferring member. Even when the door is opened, it is impossible for the user to touch the rotation part, for example, the intermediate transferring member. In this case, when the sheet is being conveyed, the sheet is conveyed to a place where the sheet is easily removed by the user. Thereafter, the conveyance is stopped, and the rotating intermediate transferring member is held as such. The apparatus is stopped by the stop method for stopping the intermediate transferring member after cleaning the intermediate transferring member. Furthermore, when the sheet is conveyed after opening the door, or the intermediate transferring member is cleaned, the door for the user to be accessible to the rotation part including the intermediate transferring member is opened, then the whole apparatus is instantly stopped. This image forming apparatus will be described.

In the present embodiment, description of contents similar to those of the first and second embodiments will be omitted.

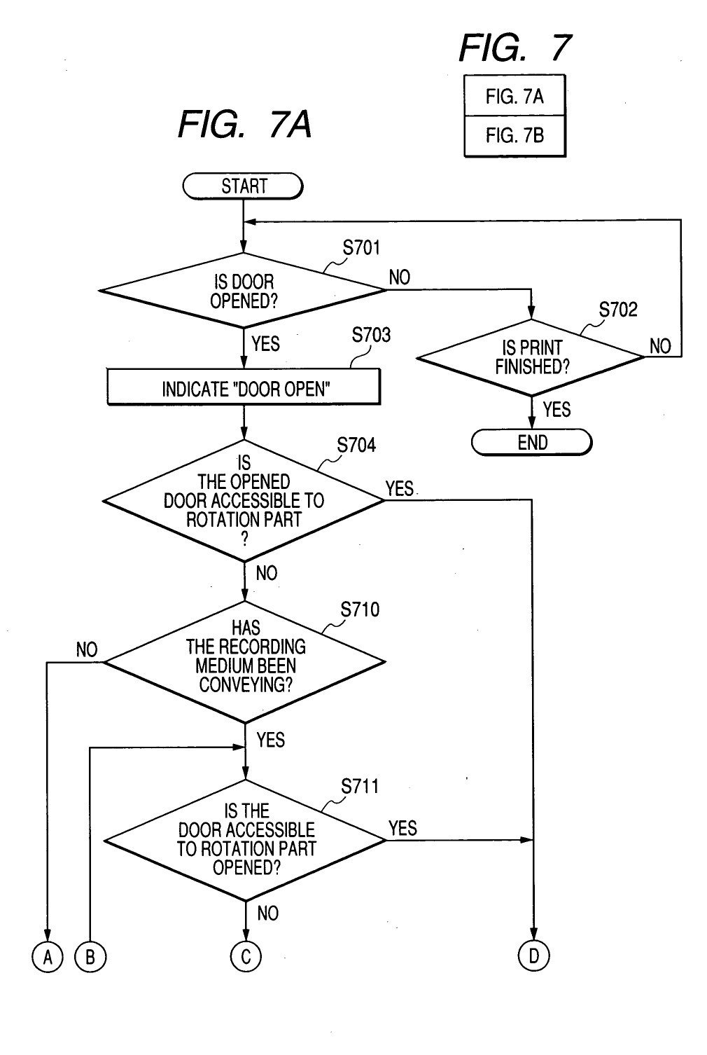

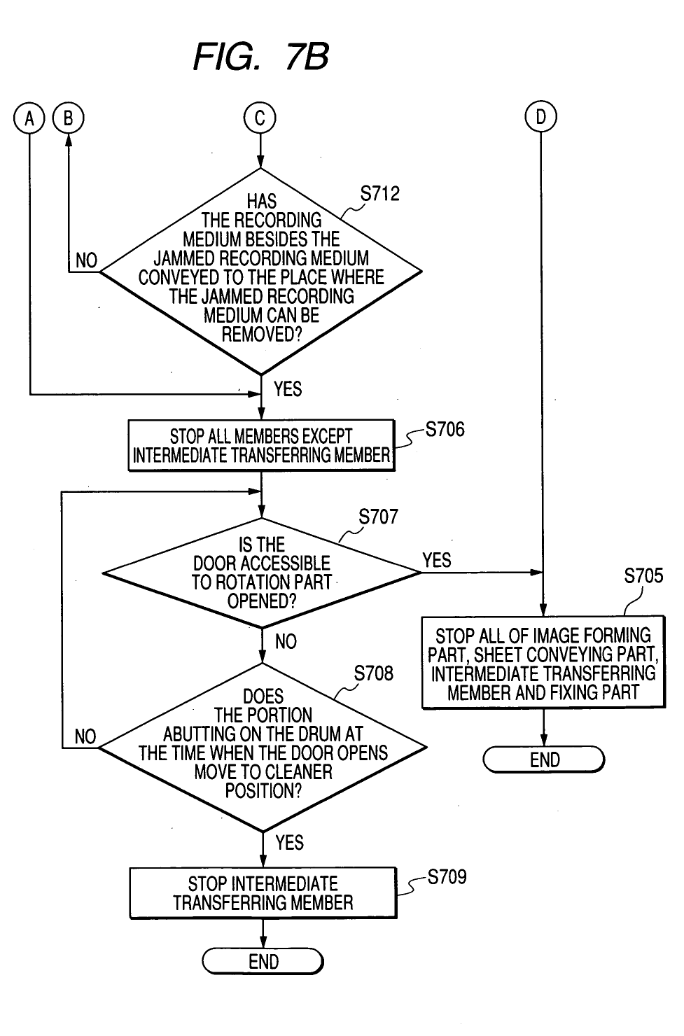

FIGS. 7A and 7B are flowcharts showing a control process of the present embodiment, and shows door open detection during the printing or the calibrating for determining image forming conditions of the image forming apparatus, and an operation of a stop process at a door open detection time.

A process of steps S701 to S703 to perform detection-display of the door open is similar to that of the steps S301 to S303 of FIG. 3 of the second embodiment.

When the door is opened, it is judged in step S704 whether or not the door for the user to be accessible to the rotation part, for example, the intermediate transferring member 12 has been opened. Accordingly, it is judged whether or not it is possible to continue the rotation of the intermediate transferring member 12. As a result, in a case where the door for the user to be accessible to the rotation part is opened, in step S705, a high-pressure circuit for forming an image is cut, and the image forming apparatus including a sheet conveying part, intermediate transferring member 12, fixing part 13 and the like is instantly stopped to thereby end a process at the door open detection time. That is, in this case, since the intermediate transferring member 12 is not cleaned, the recording material remains on the intermediate transferring member. When a door for the user to be inaccessible to the rotation part is opened in the step S704, the process shifts to step S710.

It is judged in the step S710 whether or not the image forming apparatus is conveying a recording medium. When it is judged in the step S710 that the recording medium is not conveyed, the process shifts to the step S706. When it is judged in the step S710 that the recording medium is conveyed, the conveyance of the recording medium is continued, and the process shifts to step S711.

It is judged in the step S711 whether or not the door for the user to be accessible to the rotation part is opened as a condition for instantly stopping the apparatus during the conveyance of the recording medium. When it is judged in the step S711 that the door accessible to the rotation part has been opened, in the step S705, the image forming apparatus is instantly stopped, and the process at the door open detection time is finished without completing the cleaning of the intermediate transferring member 12. When it is judged in the step S711 that the door accessible to the rotation part is not opened, the process shifts to step S712.

It is judged in step S712 whether or not the recording medium has been conveyed to a place where the medium is easily removed by the user. Here, the place where the recording medium is easily removed may be a position where a tip of the recording medium is conveyed beyond the fixing part sheet discharge sensor 20, or a position where a rear end of the recording medium is conveyed beyond the sheet discharge sensor 28 and discharged to the outside.

It is judged in the step S712 that the recording medium has been conveyed to the place where the medium is easily removed by the user, the process shifts to the step S706, and the sheet conveying part relating to the sheet conveyance except the intermediate transferring member, and the fixing part 13 are instantly stopped. While the rotating intermediate transferring member 12 is held as such, the intermediate transferring member starts to be cleaned, and the process shifts to step S707. When it is judged in the step S712 that the recording medium is not conveyed to the place where the medium is easily removed by the user, the process shifts to step S711.

A process after the cleaning of the intermediate transferring member is started in the step S706 is similar to that of the second embodiment.

As described above, in the image forming apparatus of the present embodiment, in the case where the door is opened during the printing or calibrating, when the door is opened, and it is accordingly possible for the user to touch the rotation part including the intermediate transferring member, the apparatus is stopped by the stop method for instantly stopping the apparatus. Even when the door is opened, it is impossible for the user to touch the rotation part, for example, the intermediate transferring member. In this case, when the sheet is being conveyed, the sheet is conveyed to the place where the sheet is easily removed by the user. Thereafter, the conveyance is stopped, and the rotating intermediate transferring member is held as such. The apparatus is stopped by the stop method for stopping the intermediate transferring member after cleaning the intermediate transferring member. Furthermore, when the sheet is conveyed after opening the door, or the intermediate transferring member is cleaned, the door for the user to be accessible to the rotation part including the intermediate transferring member is opened, then the whole apparatus is instantly stopped. Therefore, a serious situation in which the user is injured at a jam process time is prevented in advance, and the toner can be prevented from being fixed to the intermediate transferring member.

Moreover, in the case where the door for the user to be inaccessible to the rotation part including the intermediate transferring member is opened, the sheet is conveyed to the place where the sheet is easily removed by the user, then the sheet conveyance is stopped, and therefore usability can be enhanced.

Furthermore, it is detected whether or not the door for the user to be accessible to the rotation part including the intermediate transferring member is opened even during the sheet conveyance after the door is opened or during the cleaning of the intermediate transferring member. On judging that the door for the user to be accessible to the rotation part including the intermediate transferring member is opened, the cleaning of the intermediate transferring member is instantly interrupted, and the apparatus is stopped. Therefore, the serious situation that the user is injured at the jam process time can be prevented in advance.

### Seventh Embodiment

A seventh embodiment of the present invention will be described.

In the third embodiment, an image forming apparatus has been described. In the apparatus, in a case where a failure is detected during printing or calibrating, when an intermediate transferring member is rotated as such, and accordingly there is a possibility that another failure is caused, the apparatus is stopped by a stop method for instantly stopping the apparatus without completing the cleaning of the intermediate transferring member while a recording material (toner) remains on the intermediate transferring member. Even when the intermediate transferring member continues to be rotated as such, a multiple failure is not caused. In this case, the sheet conveyance is instantly stopped, and the rotating intermediate transferring member is held as such. The apparatus is stopped by a stop method for stopping the apparatus after cleaning the intermediate transferring member. Consequently, a serious situation including the multiple failure is prevented in advance, and the toner is prevented from being fixed to the intermediate transferring member. This apparatus has been described.

In the present embodiment, an image forming apparatus will be described. In the case where the failure is detected during the printing or calibrating, when the intermediate transferring member is rotated as such, and accordingly there is the possibility that another failure is caused, the apparatus is stopped by the stop method for instantly stopping the apparatus without completing the cleaning of the intermediate transferring member while the recording material (toner) remains on the intermediate transferring member. Even when the intermediate transferring member continues to be rotated as such, the multiple failure is not caused. In this case, when a sheet is being conveyed, the sheet is conveyed to a place where the sheet is easily removed by the user, thereafter the sheet conveyance is stopped, and the rotating intermediate transferring member is held as such. The apparatus is stopped by the stop method for stopping the intermediate transferring member after cleaning the intermediate transferring member. Furthermore, when the sheet is conveyed after occurrence of a failure, or when the intermediate transferring member is cleaned, the intermediate transferring member is rotated as such, and accordingly there is a possibility that another failure is caused. When this type of failure occurs, the whole apparatus is instantly stopped.

In the description of the present embodiment, description of contents similar to those of the first and third embodiments will be omitted.

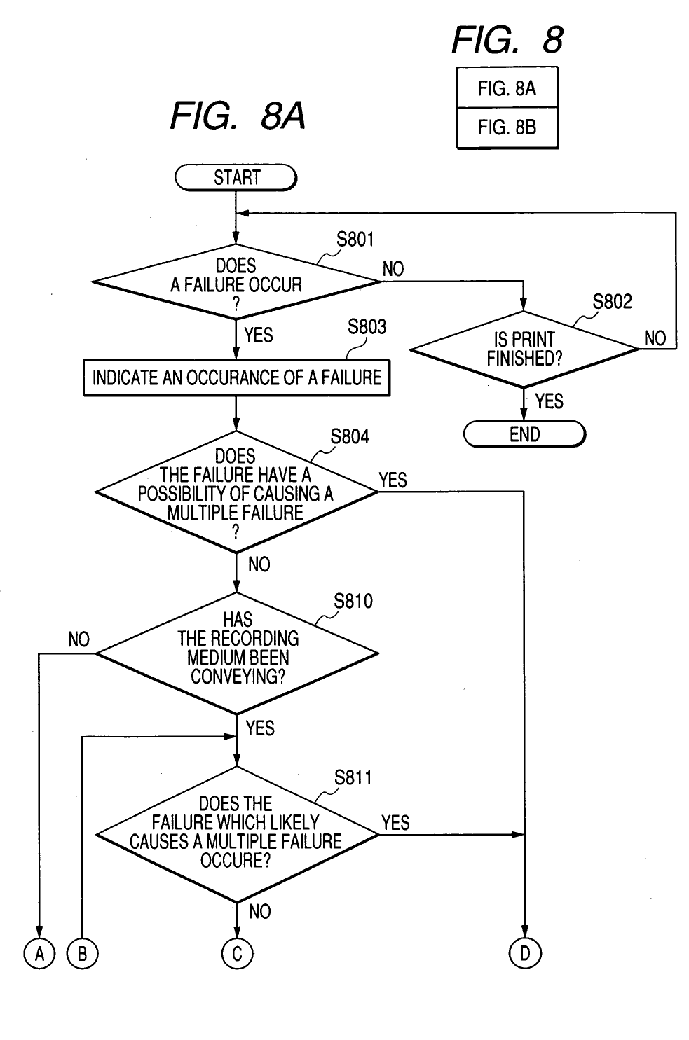

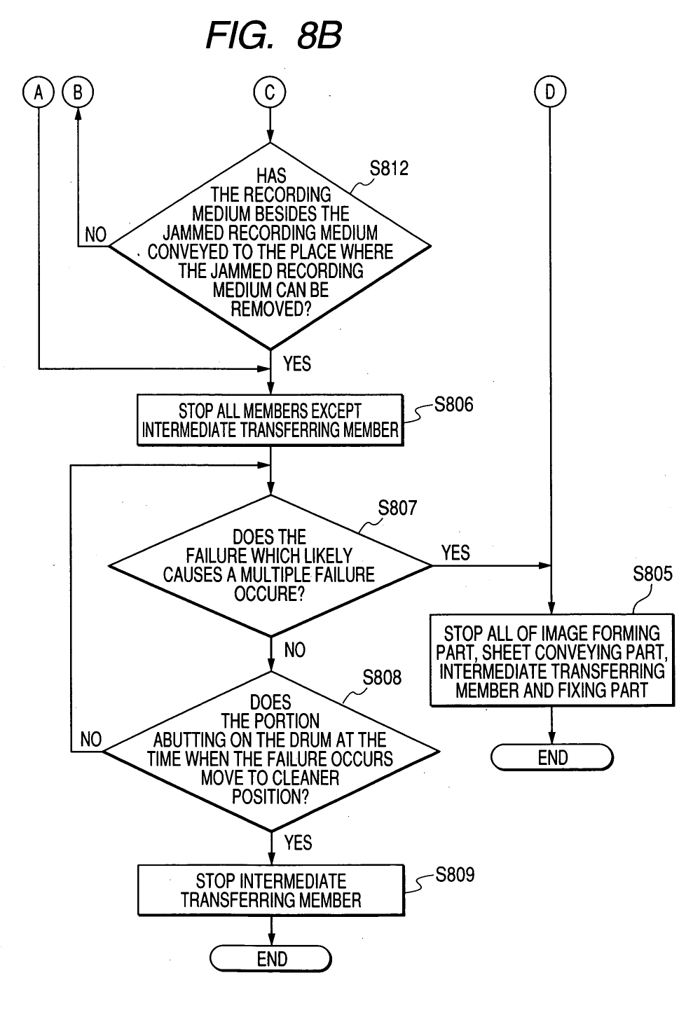

FIGS. 8A and 8B are flowcharts showing a control process of the present embodiment, and shows failure detection during the printing or the calibrating for determining image forming conditions of the image forming apparatus, and an operation of a stop process at a failure detection time.

A process of steps S801 to S803 to perform detection-display of the failure is similar to that of the third embodiment.

When it is judged in step S804 whether or not the failure possible to raise a multiple failure has occurred, when the intermediate transferring member 12 continues to be rotated, for example, because of a failure of a driving part for rotating the intermediate transferring member 12. Accordingly, it is judged whether or not it is possible to continue the rotation of the intermediate transferring member 12. As a result, in a case where the failure possible to raise the multiple failure occurs, in step S805, a high-pressure circuit for forming an image is cut, and the image forming apparatus including a sheet conveying part, intermediate transferring member 12, fixing part 13 and the like is instantly stopped to thereby end a process at a failure occurrence time. That is, in this case, since the intermediate transferring member 12 is not cleaned, the recording material remains on the intermediate transferring member. In a case where it is judged in the step S804 that a failure impossible to raise a multiple failure occurs, even when the intermediate transferring member 12 continues to be rotated, the process shifts to step S810.

It is judged in the step S810 whether or not the image forming apparatus is conveying a recording medium. When it is judged in the step S810 that the recording medium is not conveyed, the process shifts to the step S806. When it is judged in the step S810 that the recording medium is conveyed, the conveyance of the recording medium is continued, and the process shifts to step S811.

It is judged in the step S811 whether or not the failure possible to raise the multiple failure occurs, when the intermediate transferring member 12 continues to be rotated as a condition for instantly stopping the apparatus during the conveying of the recording medium. When it is judged in the step S811 that the failure possible to raise the multiple failure occurs, in the step S805, the image forming apparatus is instantly stopped, and the process at the failure detection time is finished without completing the cleaning of the intermediate transferring member 12. When it is judged in the step S811 that the failure possible to raise the multiple failure does not occur, the process shifts to step S812.

It is judged in the step S812 whether or not the recording medium has been conveyed to a place where the medium is easily removed by the user. Here, the place where the recording medium is easily removed may be a position where a tip of the recording medium is conveyed beyond the fixing part sheet discharge sensor 20, or a position where a rear end of the recording medium is conveyed beyond the sheet discharge sensor 28 and discharged to the outside of the apparatus.

It is judged in the step S812 that the recording medium has been conveyed to the place where the medium is easily removed by the user, the process shifts to the step S806, and the sheet conveying part relating to the sheet conveyance except the intermediate transferring member, and the fixing part 13 are instantly stopped. While the rotating intermediate transferring member 12 is held as such, the intermediate transferring member starts to be cleaned, and the process shifts to step S807. When it is judged in the step S812 that the recording medium is not conveyed to the place where the recording medium is easily removed by the user, the process shifts to step S811.

A process after the cleaning of the intermediate transferring member is started in the step S806 is similar to that of the third embodiment.

As described above, in the image forming apparatus of the present embodiment, in the case where the failure is detected during the printing or calibrating, when the intermediate transferring member is rotated as such, and accordingly there is the possibility that another failure is caused, the apparatus is stopped by the stop method for instantly stopping the apparatus. Even when the intermediate transferring member continues to be rotated as such, the multiple failure is not caused. In this case, when the sheet is being conveyed, the sheet is conveyed to the place where the sheet is easily removed by the user, thereafter the conveyance is stopped, and the rotating intermediate transferring member is held as such. The apparatus is stopped by the stop method for stopping the intermediate transferring member after cleaning the intermediate transferring member. Furthermore, when the sheet is conveyed after the occurrence of the failure, or when the intermediate transferring member is cleaned, the intermediate transferring member is rotated as such, and accordingly there is a possibility that another failure is caused. When this type of failure occurs, the whole apparatus is instantly stopped. Therefore, a serious situation including the multiple failure is prevented in advance, and the toner can be prevented from being fixed to the intermediate transferring member.

Moreover, even when the intermediate transferring member continues to be rotated as such, the failure that does not cause the multiple failure occurs. In this case, the sheet is conveyed to the place where the sheet is easily removed, and the sheet conveyance is stopped. Therefore, usability can be enhanced.

Furthermore, it is detected whether or not the failure possible to raise the other failure has occurred, when the intermediate transferring member is rotated as such even during the sheet conveyance after the failure occurrence or during the cleaning of the intermediate transferring member. On judging that the failure possible to raise the other failure, when the intermediate transferring member is rotated as such, the cleaning of the intermediate transferring member is instantly interrupted, and the apparatus is stopped. Therefore, the serious situation including the multiple failure can be prevented in advance.

### Eighth Embodiment

An eighth embodiment of the present invention will be described.

In the fourth embodiment, an image forming apparatus has been described. In the apparatus constituted in such a manner as to receive a signal for emergently stopping the apparatus from the outside and stop, in a case where an emergency stop designation signal is detected during printing or calibrating, when a signal for instantly stopping the apparatus is received, the apparatus is stopped by a stop method for instantly stopping the apparatus without completing cleaning of an intermediate transferring member while a recording material (toner) remains on the intermediate transferring member. When the emergency stop designation signal is received in such a manner as to continue rotating the intermediate transferring member as such, the sheet conveyance is instantly stopped, and the rotating intermediate transferring member is held as such. The apparatus is stopped by a stop method for stopping the apparatus after cleaning the intermediate transferring member. Consequently, the apparatus is stopped by an optimum method in accordance with a purpose for stopping the apparatus. This apparatus has been described.

In the present embodiment, an image forming apparatus will be described. In the apparatus constituted in such a manner as to receive the signal for emergently stopping the apparatus from the outside and stop, in the case where the emergency stop designation signal is detected during the printing or calibrating, when the signal for instantly stopping the apparatus without completing the cleaning of the intermediate transferring member while the recording material (toner) remains on the intermediate transferring member is received, the apparatus is stopped by the stop method for instantly stopping the apparatus. When the emergency stop designation signal is received in such a manner as to continue rotating the intermediate transferring member as such, and when the sheet is being conveyed, the sheet is conveyed to a place where the sheet is easily removed by a user, thereafter the sheet conveyance is stopped, and the rotating intermediate transferring member is held as such. The apparatus is stopped by the stop method for stopping the intermediate transferring member after cleaning the intermediate transferring member. Furthermore, in a case where a signal for stopping the members immediately is received at the time when the sheet is conveyed after receiving the emergency stop designation signal, or when the intermediate transferring member is cleaned, the whole apparatus is instantly stopped.

In the present embodiment, description similar to that of the first or fourth embodiment will be omitted.

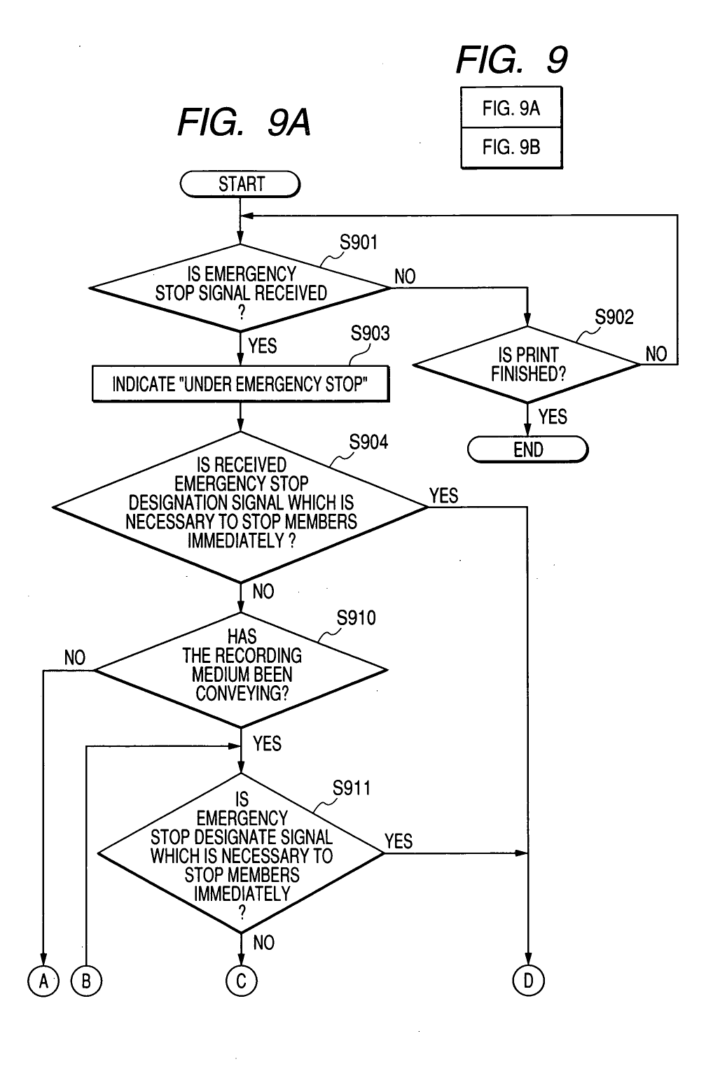

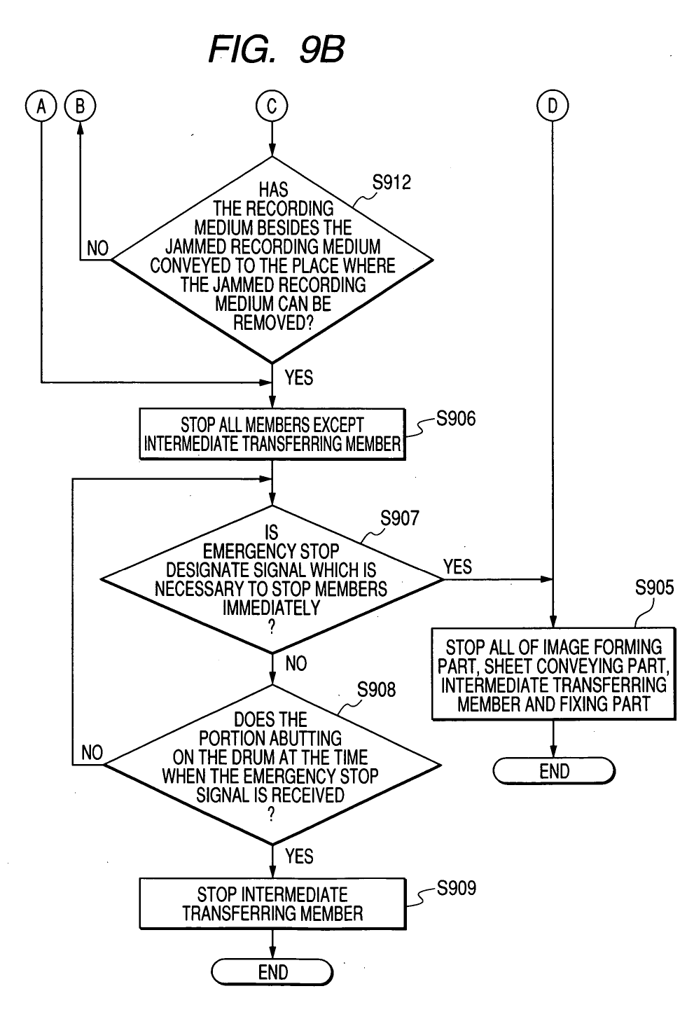

FIGS. 9A and 9B are flowcharts showing a control process of the present embodiment, and shows emergency stop designation signal detection during the printing or the calibrating for determining image forming conditions of the image forming apparatus in the image forming apparatus constituted in such a manner as to receive the signal for emergently stopping the apparatus from the outside and stop, and an operation of a stop process at an emergency stop designation signal detection time.

A process of steps S901 to S903 to perform detection-display of the emergency stop designation signal is similar to that of the fourth embodiment.

It is judged in step S904 whether or not the emergency stop designation signal to stop the apparatus immediately has been received. The signal is issued in order to immediately stop the apparatus and inspect a stop state of the apparatus. For example, a serviceman measures a slip amount of the sheet supply roller of the image forming apparatus in a test mode. Accordingly, it is judged whether or not it is possible to continue the rotation of the intermediate transferring member 12. As a result, in a case where the emergency stop designation signal to stop members immediately is received, in step S905, a high-pressure circuit for forming an image is cut, and the image forming apparatus including a sheet conveying part, intermediate transferring member 12, fixing part 13 and the like is instantly stopped to thereby end a process at the time when the emergency stop designation signal is received. That is, in this case, since the intermediate transferring member 12 is not cleaned, the recording material remains on the intermediate transferring member. In a case where a usual emergency stop designation signal is received in the step S904, the process shifts to step S910.

It is judged in the step S910 whether or not the image forming apparatus is conveying a recording medium. When it is judged in the step S910 that the recording medium is not conveyed, the process shifts to the step S906. When it is judged in the step S910 that the recording medium is conveyed, the conveyance of the recording medium is continued, and the process shifts to step S911.

It is judged in the step S911 whether or not the emergency stop designation signal to stop the members immediately as a condition for instantly stopping the apparatus during the conveyance of the recording medium. When it is judged in the step S911 that the emergency stop designation signal to stop the members immediately is not received, the process shifts to step S912.

It is judged in step S912 whether or not the recording medium has been conveyed to a place where the medium is easily removed by the user. Here, the place where the recording medium is easily removed may be a position where a tip of the recording medium is conveyed beyond the fixing part sheet discharge sensor 20, or a position where a rear end of the recording medium is conveyed beyond the sheet discharge sensor 28 and discharged to the outside of the apparatus.

It is judged in the step S912 that the recording medium has been conveyed to the place where the medium is easily removed by the user, the process shifts to the step S906, and the sheet conveying part relating to the sheet conveyance except the intermediate transferring member, and the fixing part 13 are instantly stopped. While the rotating intermediate transferring member 12 is held as such, the intermediate transferring member starts to be cleaned, and the process shifts to step S907. When it is judged in the step S912 that the recording medium is not conveyed to the place where the medium is easily removed by the user, the process shifts to step S911.

A process after the cleaning of the intermediate transferring member is started in the step S906 is similar to that of the fourth embodiment.

As described above, in the image forming apparatus of the present embodiment, in the image forming apparatus constituted in such a manner as to receive the signal for emergently stopping the apparatus from the outside and stop, in the case where the emergency stop designation signal is detected during the printing or calibrating, when the signal for instantly stopping the apparatus is received, the apparatus is stopped by the stop method for instantly stopping the apparatus. When the emergency stop designation signal is received in such a manner as to continue rotating the intermediate transferring member as such, and when the sheet is being conveyed, the sheet is conveyed to the place where the sheet is easily removed by the user, thereafter the sheet conveyance is stopped, and the rotating intermediate transferring member is held as such. The apparatus is stopped by the stop method for stopping the intermediate transferring member after cleaning the intermediate transferring member. Furthermore, in a case where a signal for stopping the members immediately is received at the time when the sheet is conveyed after receiving the emergency stop designation signal, or when the intermediate transferring member is cleaned, the whole apparatus is instantly stopped. Therefore, the apparatus can be stopped by an optimum method in accordance with a purpose for stopping the apparatus.

Moreover, when the emergency stop designation signal is received in such a manner as to continue rotating the intermediate transferring member as such, the sheet is conveyed to the place where the sheet is easily removed by the user, and the sheet conveyance is stopped. Therefore, the usability can be enhanced.

Furthermore, it is detected whether or not the signal to stop the members immediately is received even during the sheet conveyance after receiving the emergency stop designation signal or during the cleaning of the intermediate transferring member. On judging that the signal to stop the members immediately has been received, the cleaning of the intermediate transferring member is instantly interrupted, and the apparatus is stopped. Therefore, the apparatus can be stopped in an optimum method in accordance with a purpose for stopping the apparatus.

Other objects, constitutions, and effects of the present invention will be apparent from the following detailed description and drawing.

This application claims priority from Japanese Patent Application No. 2004-055984 filed on Mar. 1, 2004, which is hereby incorporated by reference herein.

1. An image forming apparatus comprising:
an intermediate transferring member suitable for transferring an image formed by a recording material;
a cleaner suitable for recovering the recording material on the intermediate transferring member; and
a controller suitable for selectively executing a step of stopping the intermediate transferring member while the recording material remains on the intermediate transferring member and a step of stopping the intermediate transferring member after recovering the recording material on the intermediate transferring member by the cleaner based on conditions in a case where the conditions for stopping the intermediate transferring member during rotation of the intermediate transferring member are satisfied.

2. The image forming apparatus according to claim 1, wherein the controller instantly stops conveyance of a recording medium when conveying the recording medium, and further stops the intermediate transferring member after recovering the recording material on the intermediate transferring member by the cleaner in a case where conditions to stop the intermediate transferring member after recovering the recording material on the intermediate transferring member by the cleaner are satisfied.

3. The image forming apparatus according to claim 1, wherein the controller stops conveyance of a recording medium after conveying the recording medium to a predetermined position during the conveying of the recording medium, and further stops the intermediate transferring member after recovering the recording material on the intermediate transferring member by the cleaner in a case where conditions to stop the intermediate transferring member after recovering the recording material on the intermediate transferring member by the cleaner are satisfied.

4. The image forming apparatus according to claim 1, wherein the controller executes a control in such a manner as to instantly stop the intermediate transferring member, when conditions to stop the intermediate transferring member are conditions to instantly stop the intermediate transferring member in a case where another condition to stop the intermediate transferring member is further satisfied during execution of the step of stopping the intermediate transferring member after recovering the recording material on the intermediate transferring member by the cleaner.

5. The image forming apparatus according to claim 1, further comprising:
jam detecting means for detecting a jam,
wherein conditions to execute the step of stopping the intermediate transferring member after recovering the recording material on the intermediate transferring member by the cleaner include a condition that the jam detecting means detects a jam other than a winding jam of a recording medium around the intermediate transferring member.

6. The image forming apparatus according to claim 1, further comprising:
jam detecting means for detecting a jam,
wherein conditions to execute the step of stopping the intermediate transferring member while the recording material remains on the recording material include a condition that the jam detecting means detects a winding jam of a recording medium around the intermediate transferring member.

7. The image forming apparatus according to claim 1, further comprising:
door open/close detecting means for detecting an open/close state of a door of an image forming apparatus main body,
wherein conditions to execute the step of stopping the intermediate transferring member after recovering the recording material on the intermediate transferring member by the cleaner include a condition that the door open/close detecting means detects that a door inaccessible to a rotation part even when opened during an image forming operation has been opened.

8. The image forming apparatus according to claim 1, further comprising:
door open/close detecting means for detecting an open/close state of a door of an image forming apparatus main body,
wherein conditions to execute the step of stopping the intermediate transferring member while the recording material remains on the intermediate transferring member include a condition that the door open/close detecting means detects that a door accessible to a rotation part when opened during an image forming operation has been opened.

9. The image forming apparatus according to claim 1, further comprising:
communication means,
wherein conditions to execute the step of stopping the intermediate transferring member after recovering the recording material on the intermediate transferring member by the cleaner include a condition that an emergency stop instruction for preventing the intermediate transferring member from being instantly stopped is input from the outside through the communication means.

10. The image forming apparatus according to claim 1, further comprising:
communication means,
wherein conditions to execute the step of stopping the intermediate transferring member while the recording material remains on the intermediate transferring member include a condition that an emergency stop instruction for instantly stopping the intermediate transferring member is input from the outside through the communication means.

11. The image forming apparatus according to claim 1, further comprising:
failure detecting means,
wherein conditions to execute the step of stopping the intermediate transferring member after recovering the recording material on the intermediate transferring member by the cleaner include a condition that the failure detecting means detects a failure of a driving part of the intermediate transferring member.

12. The image forming apparatus according to claim 1, further comprising:
failure detecting means,
wherein conditions to execute the step of stopping the intermediate transferring member while the recording material remains on the recording material include a condition that the failure detecting means detects a failure other than a failure of a driving part of the intermediate transferring member.

13. An image forming apparatus comprising:
an intermediate transferring member suitable for transferring an image formed by a recording material;
a cleaner suitable for recovering the recording material on the intermediate transferring member; and
a controller suitable for stopping the intermediate transferring member during rotation of the intermediate transferring member based on a predetermined condition,
wherein the controller judges whether or not it is possible to continue the rotation of the intermediate transferring member in order to recover the recording material on the intermediate transferring member by the cleaner, and stops the intermediate transferring member at a timing based on a judgment result.

14. The image forming apparatus according to claim 13, wherein the controller instantly stops conveyance of a recording medium when conveying the recording medium, and further stops the intermediate transferring member after recovering the recording material on the intermediate transferring member by the cleaner in a case where conditions to stop the intermediate transferring member after recovering the recording material on the intermediate transferring member by the cleaner are satisfied.

15. The image forming apparatus according to claim 13, wherein the controller stops conveyance of a recording medium after conveying the recording medium to a predetermined position during the conveying of the recording medium, and further stops the intermediate transferring member after recovering the recording material on the intermediate transferring member by the cleaner in a case where conditions to stop the intermediate transferring member after recovering the recording material on the intermediate transferring member by the cleaner are satisfied.
